(19) United States
(12) Patent Application Publication
(10) Pub. No.: US 2006/0004767 A1
(43) Pub. Date: Jan. 5, 2006

(54) Systems and methods for collecting, representing, transmitting, and interpreting usage and state data for software

(75) Inventors: Claudiu G. Diaconu, Bellevue, WA (US); Mei-Hsuan Chiu, Issaquah, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 10/973,744

(22) Filed: Oct. 26, 2004

Related U.S. Application Data
(60) Provisional application No. 60/584,211, filed on Jun. 30, 2004.

(51) Int. Cl. G06F 17/30

(52) U.S. Cl. 707/10

(57) ABSTRACT

The present invention provides systems and methods for automatically gathering computer data from a plurality of networked computer systems. In one aspect, a system is provided for automatically generating computer usage and state data. The system includes an application layer associated with an operating system to gather data from one or more computer components, wherein a collection file specifies the data to gather. The collection file includes query information for directing the application layer with respect to what type of information to gather from various components or modules in the computer system. An automated task scheduler operates with the collection file to transmit gathered data to a centralized collection agency for further analysis.

### CROSS REFERENCE TO RELATED APPLICATION

This application claims priority to U.S. Provisional Patent Application Ser. No. 60/584,211 filed Jun. 30, 2004, entitled SYSTEM FOR COLLECTING, REPRESENTING, TRANSMITTING, AND INTERPRETING USAGE AND STATE DATA FOR SOFTWARE, the entirety of which is incorporated herein by reference.

### TECHNICAL FIELD

The subject invention relates generally to systems and methods that facilitate gathering computer usage and diagnostic data over a network such as the Internet, and more particularly, the subject invention relates to a system that employs a collection file to specify computer usage information that is queried via a generalized application layer in accordance with an automated scheduling component, wherein the information is gathered over the network at a centralized data store for further analysis.

### BACKGROUND OF THE INVENTION

The ability to manage and perform system diagnostics from a central or remote location has become increasingly important to today's business climate. This interest in remote management arose in part because of the increased size and geographically dispersed nature of modern computer networks, and also due to the escalating costs associated with maintaining such networks (often referred to as the Total Cost of Ownership, or TCO). Support for remote management and diagnostics allows enterprise system administrators to more quickly and cost-effectively maintain their systems, without requiring them to visit each individual desktop. The benefits of remote management and diagnostics—faster response to issues, simplified server management, the ability to use off-site technical specialists for problem solving or system repair—result in less downtime and more satisfied computer users.

In general, modern computing systems need to be able to remotely manage servers, clients, and workstations and the software that runs on these computers. The ability to remotely manage and diagnose problems on servers and workstations allows customers to reduce TCO and lower system management workload. System administrators need the ability to define software policies that specify the applications, data, and desktop environment a user can access. These goals include automatically updating and synchronizing applications, resources, and data on a per-computer or per-user basis.

An important component in remote network diagnostic capabilities is for vendors of software products to receive data over time relating to the performance of their respective software offerings. This data is employed to monitor such aspects as computer hardware performance, system crashes, device driver problems, software component interactions, and so forth. Based upon an analysis of the data, software makers can improve their products over time by tweaking or re-designing software to address detected problems. Moreover, beyond merely responding to problems, software suppliers can monitor data over time in order to continually improve performance of software products into the future.

Although remote data collection has been employed to improve many products, current methods for gathering such data is inefficient and difficult to scale as systems grow—such as when new hardware and software is added. One problem relates to that individual software applications are required to supply their own interfaces for supplying data regarding the application's individual performance. Thus, if a new application or driver is added to the system, a corresponding diagnostic interface would also have to be installed—if any exist for such application. Making matters worse, consistent data is difficult acquire since individual applications supplying the data (if they supply any at all) have no common theme for producing the data and/or cooperating between components. Without commonality between components, data gathered for diagnosing or improving systems can be problematic to analyze.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention relates to systems and methods that facilitate gathering computer usage and diagnostic data over a network in a generalized and scalable architecture for collecting/analyzing such data. In one aspect, a system is provided that employs a collection file (or files) to specify computer usage and diagnostic information to be gathered from one or more components of a computer system such as from applications, hardware drivers, and computer operating system components, for example. The specified information is queried over time in accordance with a generalized application layer and an automated task scheduling component, wherein the requested information designated in the collection file is transmitted over the network to a centralized data store for further analysis. The analyzed data can be employed to mitigate or predict system/component problems and to improve software/system performance over time by upgrading components in response to detected problems or in response to monitoring data, implementing changes, and testing results that yield improvements to the respective changes.

The collection file can be updated from remote network locations fostering increased data gathering scalability and capability as systems change over time. Thus, as new components are added or as system conditions change, the collection file can be updated remotely across a plurality of networked systems, whereby the scheduling component and application layer associated with the respective systems automatically respond to generate new data in accordance with the updates. In this manner, several problems are mitigated. When new components are added to the respective systems, or system configurations change, and/or differing types of data collections are desired, the collection file can be updated as centralized or global commands that automatically set in motion new data generation capabilities from many networked systems via the application layer and scheduler. This relieves conventional requirements of having separate applications designed, installed and coordinated with other disparate/non-related applications in order to generate the data. Also, the system is easily scaled for growth since a generalized architecture is provided to query data from individual components in a consistent/global manner from various systems and with a system-level view of substantially all system components and functionality in mind.

To the accomplishment of the foregoing and related ends, certain illustrative aspects of the invention are described herein in connection with the following description and the annexed drawings. These aspects are indicative of various ways in which the invention may be practiced, all of which are intended to be covered by the present invention. Other advantages and novel features of the invention may become apparent from the following detailed description of the invention when considered in conjunction with the drawings.

### BRIEF DESCRIPTION OF THE DRAWINGS

FIG. 1 is a schematic block diagram illustrating a data gathering and transmission system in accordance with an aspect of the present invention.

FIG. 2 is a schematic block diagram illustrating more detailed aspects of data collection input files in accordance with an aspect of the present invention.

FIGS. 3 and 4 are flow diagrams illustrating data gathering, sending, and scheduling in accordance with an aspect of the present invention.

FIG. 5 illustrates example usage and state data in accordance with an aspect of the present invention.

FIGS. 6-8 illustrates an example user interfaces for displaying gathered data in accordance with an aspect of the present invention.

FIG. 9 is a schematic block diagram illustrating a suitable operating environment in accordance with an aspect of the present invention.

FIG. 10 is a schematic block diagram of a sample-computing environment with which the present invention can interact.

### DETAILED DESCRIPTION OF THE INVENTION

The subject invention provides systems and methods for automatically gathering computer data from a plurality of networked computer systems. In one aspect, a system is provided for automatically generating computer usage and state data. The system includes an application layer associated with an operating system to gather data from one or more computer components, wherein a collection file specifies the data to gather. The collection file includes query and timing information for directing the application layer with respect to what type of information to gather from various components or modules in the computer system. In this manner, data can be collected from a plurality of systems operating on the network. If new information gathering is desired, the collection files residing on the remote computer systems can be updated across the network. An automated task scheduler operates with the collection file to gather/transmit the data to a centralized collection agency for further analysis.

As used in this application, the terms “component,” “scheduler,” “system,” “layer,” “object,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

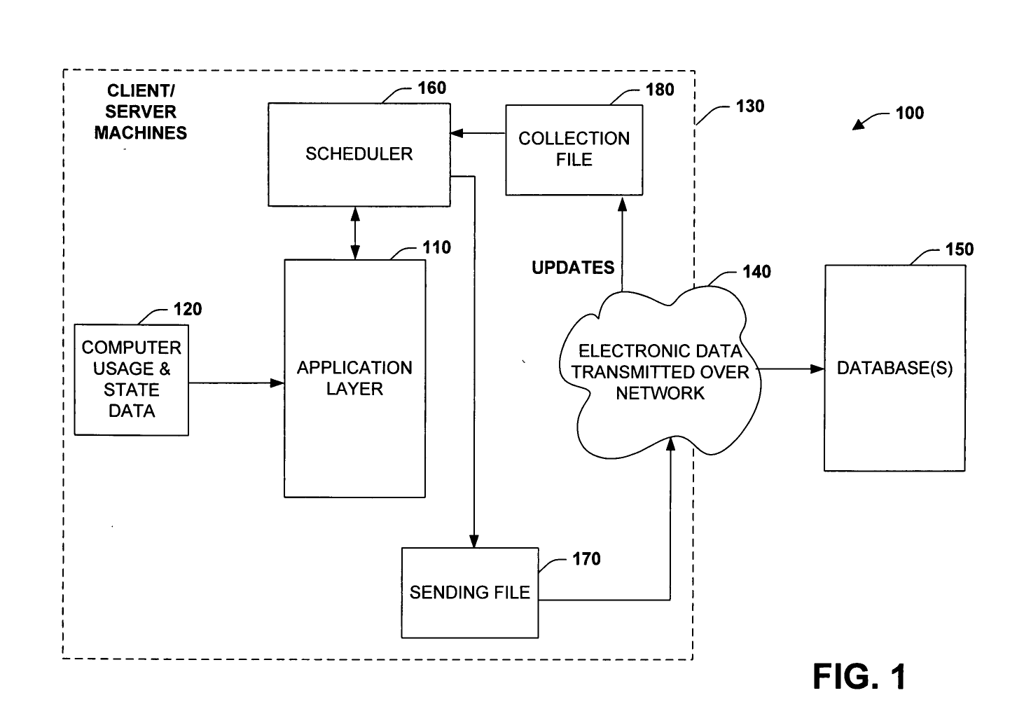

Referring initially to FIG. 1, a data gathering and transmission system 100 is illustrated in accordance with an aspect of the subject invention. The system 100 includes an application layer 110 that receives computer and usage data 120 in a client machine 130 and transmits the data over a network 140 to a centralized database 150 (or databases) for further analysis. As can be appreciated, a plurality of client machines 130 (or servers) can exist having respective usage and state data 120 transmitted to the database 150 over the network 140 in accordance with the subject invention. A scheduler 160 executes at differing or predetermined time intervals to send data across the network 140 via a sending file 170 (e.g., XML file). The scheduler 160 operates from instructions within a collection file 180 to query the application layer 110 for the computer usage and state data 120. As will be described in more detail below, the collection file 180 (or input file) can include query and timing commands that are directed to the application layer 110 which in turn gathers various data from the client machine 130 (can also be a server or servers).

In order to improve software and hardware products, information is collected at the database 150 that allows software producers to understand how products are being utilized by customers and what type of problems they are encountering when using such products. This also enables improving design of the products along with testing processes. The system 100 automates this task by gathering information and sending it periodically to the database 150 (e.g., via email or other medium). The data collected includes but is not limited to event logs which reflect client or server availability and failures, hardware profile and utilization information on services such as messaging and the web. The information can be retrieved through the application layer 110 (e.g., Windows Management Infrastructure Application Programming Interfaces—WMI API), wherein the result is formatted into an XML file or other type and sent back to the database 150 through SMTP, HTTP or other network protocol.

When the scheduler 160 is run, it can execute a task that is to be performed currently, determines the task that needs to be performed next, calculates the time the next gathering of data should be carried out, and schedules the task to run at that time. In general, the system 100 has three main tasks, including collecting of data, updating setup files from the web and sending collected data back to the database 150. These include:

1. Data sending module (not shown):

A component that sends data and is loaded by the scheduler 160 on a regular basis.

2. Scheduler 160:

A component that schedules time to call Data Collection component or Data Sending component or check any modification to the data collection input file 180 recurrently.

3. Collection file 180 for data collection:

This file offers information about when and what data needs to be collected in XML or other format and is stored locally on the client machine 130. There can be a registry key that indicates the location of this file. The collection file 180 generally includes several sets of information including time schedule and queries (e.g., Windows Query Language) also which machine that collects the information. An agent component can collect data locally on a server where the tool is installed as well as from client machines in the server domain. The queries which have similar execution schedules are typically run under the same node. Its time schedule will be the attributes of the node that the queries belong to. Generally, queries specify what data needs to be collected, whereby more than one query can be included at one time setting. When the queries are in the same time setting, they are generally passed to the data collection module and executed together. Other tasks include compressing the files, encrypting the files, auto generating a list of client machines in the domain and collecting different sets of data, according to an input file and machine groups. For example, in the input file, users can specify to collect some set of data from the client machines from one type of operating system (e.g., Windows XP) and another set of data from the client machines having a different type of operating system (e.g., Windows 2000).

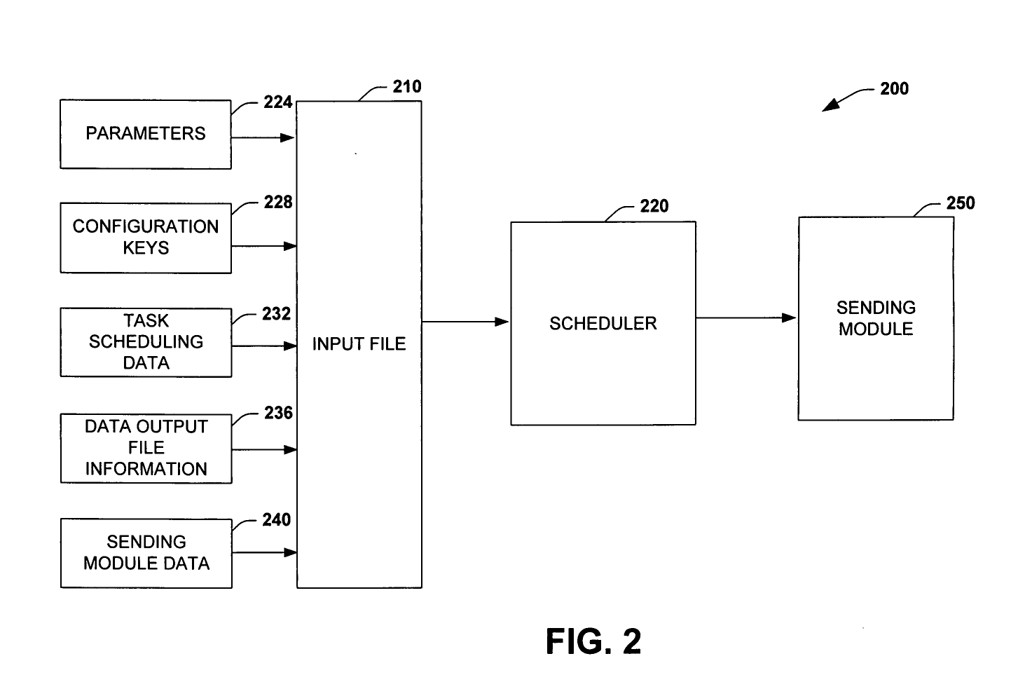

Referring now to FIG. 2, a system 200 illustrates more detailed aspects of data collection input files 210 and scheduler 220 in accordance with an aspect of the present invention. The data collection file 210 offers information about when and what computer data is to be collected in XML or other type format by the scheduler 220. As noted above, the collection file 210 typically contains two types of information: time schedule and one or more queries. The queries specify what data needs to be collected at specified or calculated time frames. Time scheduling can include six or more parameters 224 listed in bold below that describe when the data should be collected. These parameters include:

Local Time: (int) Specify whether a Task Start Time is the machine local time or GMT. If it is local time, the value should be equal to 1. If it is GMT, it should be 0. By default, it can be interpreted as GMT. Task Start Time: (datetime) Time to start collecting data. The time format is mm/dd/yyyy hh:mm:ss AM(PM). e.g., Oct. 3, 2001 12:00:12 PM. If the current time has past the Task Start Time, the Task Start Time will be used as the start point with addition to the times of the frequency to compute the next task start time. Frequency: (int) Time interval to collect the data again. Its unit is seconds. Its default value is one minute. Task Count: (int) Number of times the data should be collected. Its default value is −1, which implies no limit on retrieving times. Sample Count: (int) Number of times that a set of queries with certain time setting are to be executed. Its default value is 1, which implies that the data will be collected once during this time frame. Sample Interval: (int) Delay time required between the sample's collection. Its default value is equal to 5 seconds. Sample Interval should be smaller than frequency. Otherwise, the Sample Interval will be set to the default value if the former is greater than the latter. The following provides an example commands for the data collection input file 210 configured to query data at example time intervals.

### EXAMPLE

Query: select * from Win32_PerfRawData_PerfDisk_PhysicalDisk

Sample for the input file:

The following query retrieves information about the physical disks information on the machine. This task will be carried out every 2 minutes from “2003/6/12 12:00 AM”. During each task operation, the query will be executed twice with 2 seconds as the interval.

<?xml version=”1.0”?>
<Machine>

<Collection>
<TimeSetting LocalTime= “1” TaskStartTime=”2003-6-12”

Frequency =
“120” TaskCount=”2” SampleCount=”2” SampleInterval=”2” >
<Task>SELECT * FROM Win32_PerfRawData_PerfDisk_PhysicalDisk
</Task>

</TimeSetting>

</Collection>
</Machine>

At 228, one or more keys listed in bold can be configured which control other actions of the scheduler 220. The keys 228 include task information such as for data sending including: Send XML Frequency: (DWORD) How frequent the data should be sent. Its unit is by hour. If the value is 0, no output file will be sent. Send Log Frequency: (DWORD) Interval to send the log file. Its unit is by hour. If the value is 0, no log file will be sent. Keys 228 for data checking can be provided including: Check Modification Frequency: (DWORD) How frequent to check the modification to the input file. Its unit is by hour. If the value is 0, no checking will be performed. Input File Last Write Time High: (DWORD) last time the XML input file was modified. This key is a LONGLONG number and cannot be stored in registry in this format. Therefore, this is the upper part of the number. Input File Last Write Time Low: (DWORD) last time the XML input file was modified. It is a LONGLONG number and cannot be stored in registry in this format. Therefore, this is the upper part of the number.

Keys 228 can be provided for log file size checking that include: Check Log File Size Frequency: (DWORD) How frequent to check if the log file size is too large. If the value is 0, no checking will be performed. Keys 228 for file version checking include: Data Collection Input File: (string) Where the data collection input file is located. Input File Version: (string) version of the local input file. Input File Version Url: (string) location of the text file that contains the version information of the input file on the web. Input File Url: (string) location of the input file on the web. Check Input File Version Frequency: (DWORD) frequency to check the input file version on the web.

Proceeding to 232, task scheduling data listed in bold includes: Frequency Threshold: (DWORD) If the original frequency setting is smaller than this number, it will be reset to this number. It is default to 5 seconds. Aggregation Threshold: (DWORD) If the running time for the next task is less than this number and only one sample needs to be collected at this time setting, the scheduler 220 will continue to perform the next task without waiting until its actual running time. It is default to 10 seconds. Exit Threshold: (DWORD) If the running time for the next task is less than this number, the scheduler 220 will stay in memory and sleep until the scheduled time for the next task. This number should be greater than Aggregation Threshold. It is default to 65 seconds. Link List File: (string) Specify the file path where the link list for the tasks scheduling should be saved. Log File: (string) Specify the file path of the log file that stores the error messages from the data collection tool. Log Severity: (DWORD) The higher it is, the more error messages will be written to the log file. Log Facility: (DWORD) This decides which components of the error messages will be recorded to the log file. Log File Max Size: (DWORD) The size limit of the log file. XML Output File Max Size: (DWORD) The size limit of the XML output file. DCT Job Name: (string) The scheduler name. Stop File Grow Threshold: (DWORD) If the file size grows over this number, stop writing to the file. It is default to 4 MB. Send File Hour: (DWORD) the specific hour the files should be sent. The Send File Hour and Send File Minute indicate the specific time the data should be sent. It allows the user to set the file sending time to optimize the machine performance and avoid network congestion. Send File Minute: (DWORD) the specific minute the data files should be sent.

At 236, configuration data listed in bold for configuring data output files includes: Output File: (string) The location of an XML file which stores the returned data. Collection Site Version: (string) version of collection agent or tool at data gathering site. Collection Site ID: (string) collection site GUID that is created when a data collection tool is installed and is unique to this installation.

At 240, configuration information listed in bold for a data sending module 250 is provided. This data includes: Protocol: (int) protocol through which data is sent, SMTP or HTTP. If it is sent through SMTP, the value is 0. If it is sent through HTTP, the value is 1. Smtp From Address: (string) The sender's email address. Destination Address: (string) Internet Address where collected data will be sent. Protocol Server: (string) the mail server in the domain where the machine is located and the tool is set up.

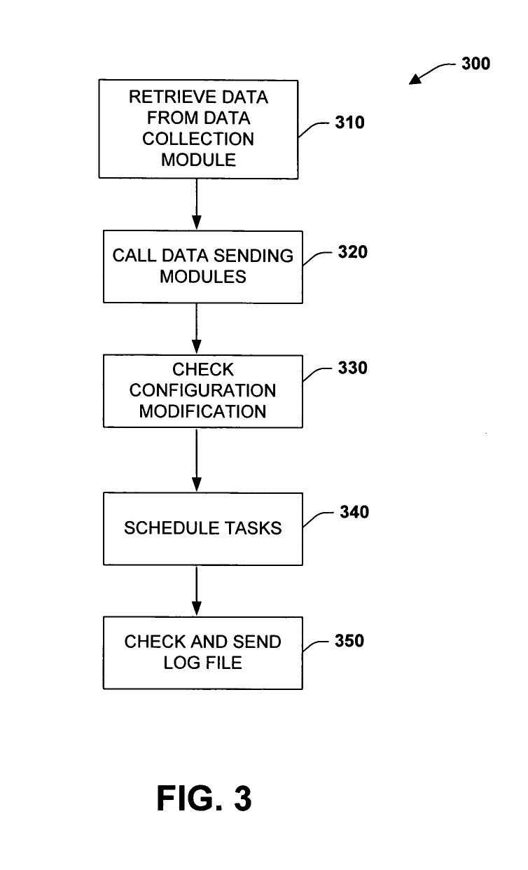

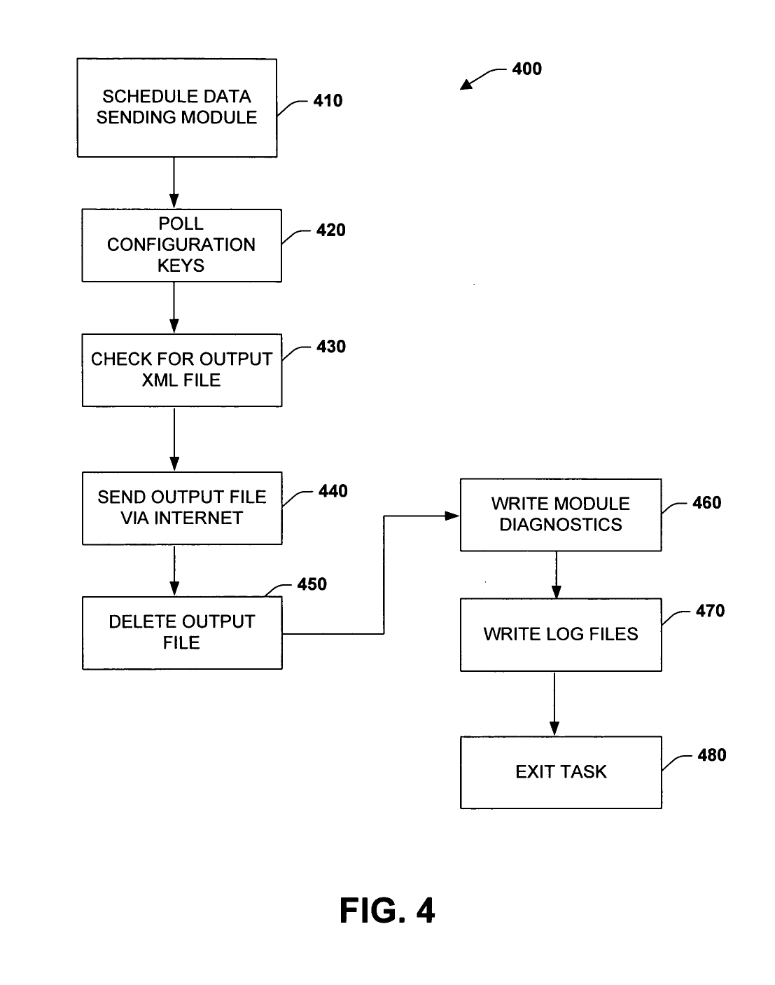

FIGS. 3 and 4, illustrate processes 300 and 400 for data gathering, sending and scheduling in accordance with an aspect of the subject invention. While, for purposes of simplicity of explanation, the methodologies are shown and described as a series or number of acts, it is to be understood and appreciated that the present invention is not limited by the order of acts, as some acts may, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

Proceeding to 310, data is retrieved from a Data Collection Module and placed into an output file. The scheduler calls a Data function, and passes a list of queries. A pointer of record sets of data can be returned and saved to an array of result data in the task node. The scheduler should not put the array of data into XML format and save it into an output file until the number of samples that are required to be collected is reached for the task node. At 320, the Data Sending module is called to send the output file or log file. The scheduler calls a data sending function to send the data. Typically, three parameters are passed to this function. The last two will be NULL. The first parameter indicates the location of the file that will be sent. The first parameter will be Null if the data sending module decides to send the XML output file.

At 330, configuration modification is checked in the collection file. This includes the information about the last time the input file was modified and is stored in the registry key value of Check Modification Frequency. The scheduler checks the discrepancy between the Check Modification Frequency value and the latest modification time for the data collection file before the Data collecting Module is called. If the number is different, the input file for data collection will be parsed through again and a new link list is generated.

At 340, the scheduler schedules tasks for gathering and sending data. Generally, the tasks will be carried out at its next running time. The scheduler can perform two options after it is done with the current task and it is not the time to do the next task-sleep or exit. Also, if the running time for the next task is greater than Aggregation Threshold, but smaller than Exit Threshold: The scheduler will stay in memory and wake up to execute later. If the Running time for the next task is greater than Exit Threshold:

The scheduler will schedule the time for a collection job to start at the running time of the next task, and save the information about the Task Nodes at a local file and exit. To save the resources on the machine, an exception is applied when it meets the following condition—Time interval between the current task and the next time is less than Aggregation Threshold and only one sample needs to be collected for the current task. The scheduler will continue to carry out the next task without waiting until its actual running time.

After the scheduler carries out the current task, it will remove the Task Node that is referenced currently out of the link list, change its Task Start Time and insert it back to the link list if the total number of task execution times has not reached the Task Count, specified in the input file. At 350, a log file is checked and sent. The scheduler checks if the size of the log file is over e.g., 2 MB before the Data Sending or Data Collection module is called. If the size is over 2 MB or other value, the scheduler calls the Data Sending module to send the log file.

Referring to FIG. 4, a process 400 illustrates an example data sending process and in accordance with an aspect of the subject invention. This following process 400 describes sending collected data via the Internet or other network. At 410, the scheduler executes a Data Sending Module according to a predetermined schedule, wherein acts 420-470 can then be performed by the data sending module. At 420, the Data Sending Module polls the following configuration keys for information: a) Read Output XML file location, b) Read protocol selection, and c) Read Internet address to send collected data.

At 430, the data sending module checks if an Output XML file exists. If the file doesn't exist, there is nothing to send. Abort and exit the sending module. If file exists, proceed. At 440, the data sending module sends the Output XML file via the Internet according to a protocol selection in the input file: a) HTTP: send file by simulating an HTML post, b) SMTP: send email to awaiting mail server. It is noted that if an email fails to be handed over to a server (e.g., SMTP server), a program or component can resend the email a number of times, according to a registry key value. To prevent from hacking, the upper limit of resending is 10 times (or other value). If a registry key value is higher than that, it stops retrying after 10 times. The number of retries that have been performed for an email can be tracked by storing it in a different email folder. For example, if an email fails to be delivered once, then it will be moved from the SendFolder1 to SendFolder2. If it fails to be delivered the second time, then it will be moved from the SendFolder2 to SendFolder3, and so forth. At 450, the Output XML file is deleted. At 460, the data sending module writes the following module diagnostics in the registry: a) Time of transmission via Internet, b) Increment number of bytes sent to date, c) Increment number of transmissions sent to date. At 470, the status regarding whether sending has succeeded or not is written to a log file. At 480, the data sending module discontinues execution until reactivated by the scheduling module.

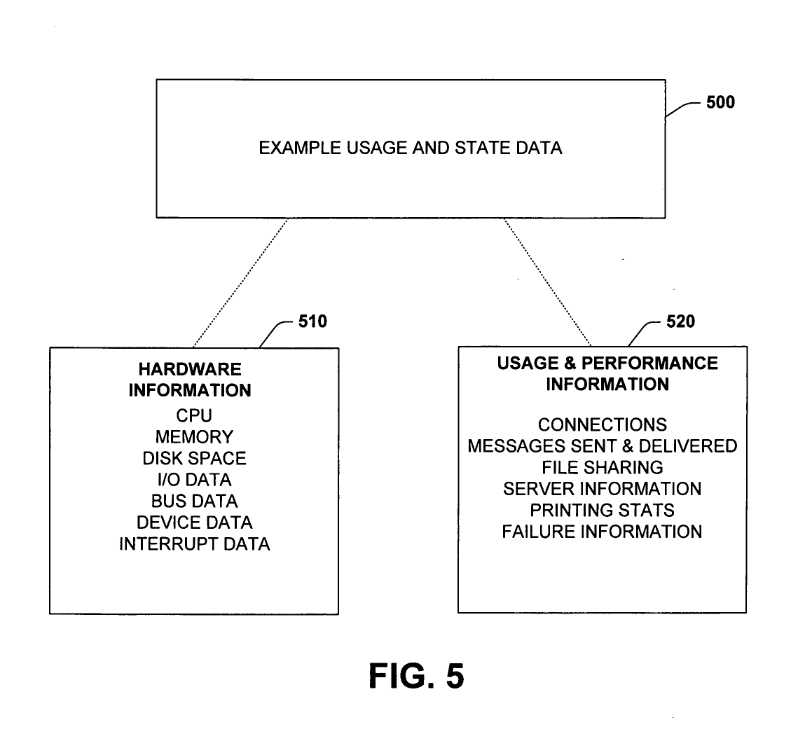

FIG. 5 illustrates example usage and state data 500 in accordance with an aspect of the subject invention. The usage and state data 500 can be related to substantially any hardware or software aspect of a computer. For instance, various hardware information 510 can be gathered at a centralized data site (or sites) across the Internet from a plurality of client and/or server machines. This can include CPU performance data, RAM memory capacity/utilization, and available disk space, for example. Hardware data 510 can also be gathered for the individual components that interact with the computer system. This can include Input or Output transactions between devices, system bus performance data including bus latencies, bus though-puts, and so forth. Device data can be gather from such peripherals as network cards, USB adapters, disk controllers, keyboard drivers, sensor drivers, mouse drivers, display drivers, printer drivers, and other software application components. Still yet other data can include gathering statistics such as system, bus, and device interrupt performance. At 520 computer usage and performance data can be gathered at the collection database. This type of data includes node connection data, message sent, delivered and received data, file sharing data, server information such as e.g., Post Office Protocol version 3 (POP3) information, statistics relating to the number of print jobs completed successfully or unsuccessfully, and general order computer, application, or device failure information (e.g., the number of hardware, software, or device crashes that have been logged before system power down).

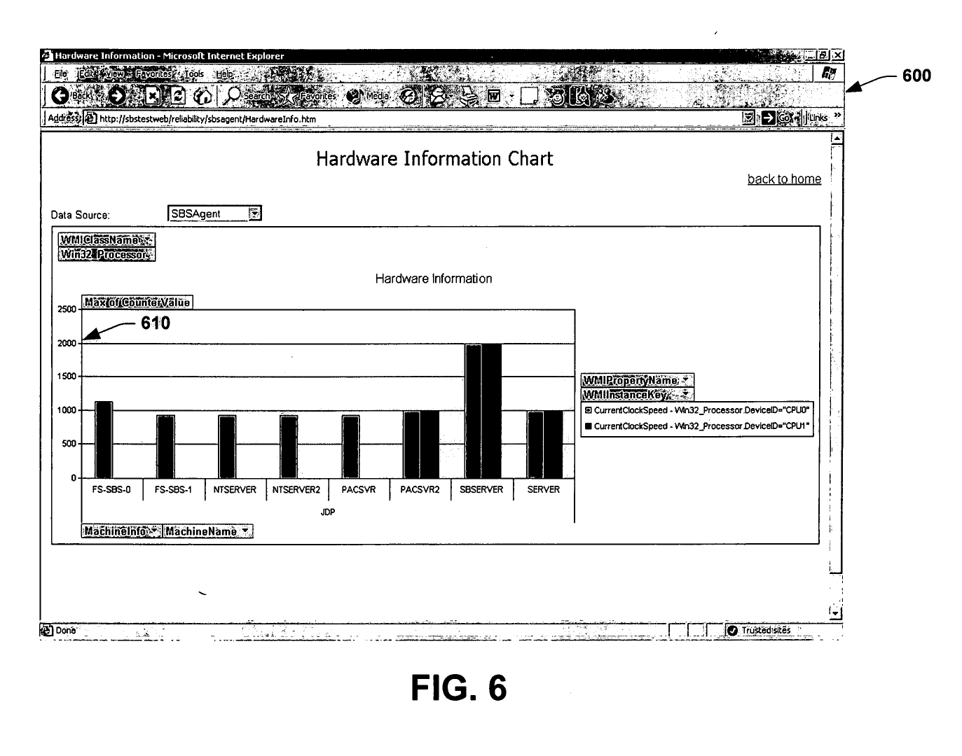

FIGS. 6-8 illustrate example user interfaces for displaying gathered data in accordance with an aspect of the subject invention. In these examples, it is noted that gathered data can be displayed and analyzed in substantially any format. This includes presenting statistical presentations such as bar graphs, pie charts, counter statistics, event logs, charts, time stamp information and so forth. As noted above, the data can be analyzed to monitor software and hardware performance over time to repair potential problems in these components and to further enhance system components over time.

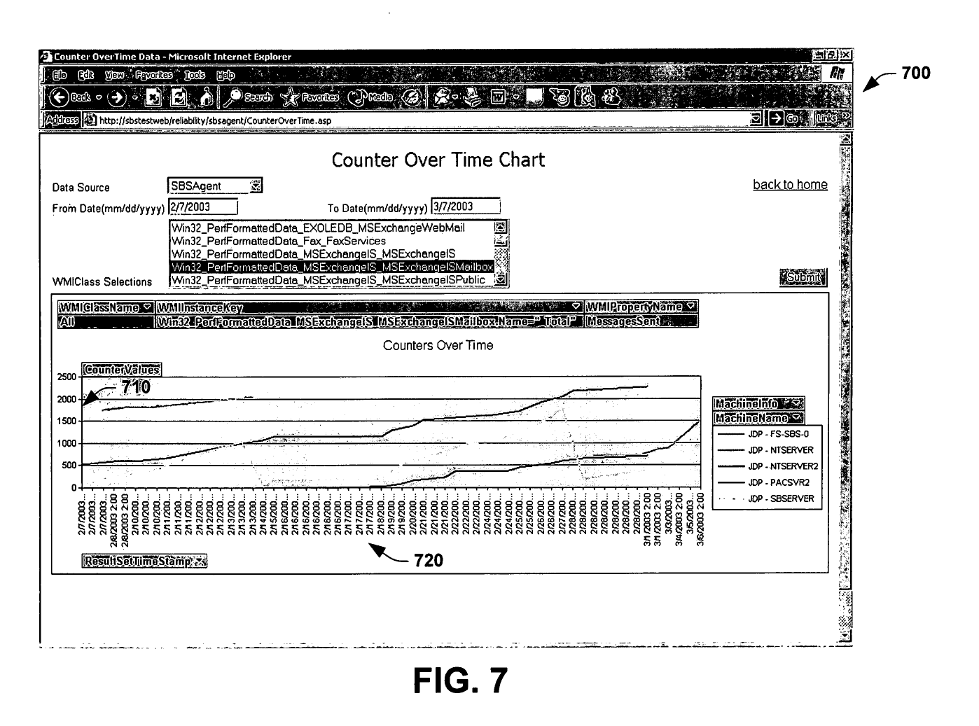

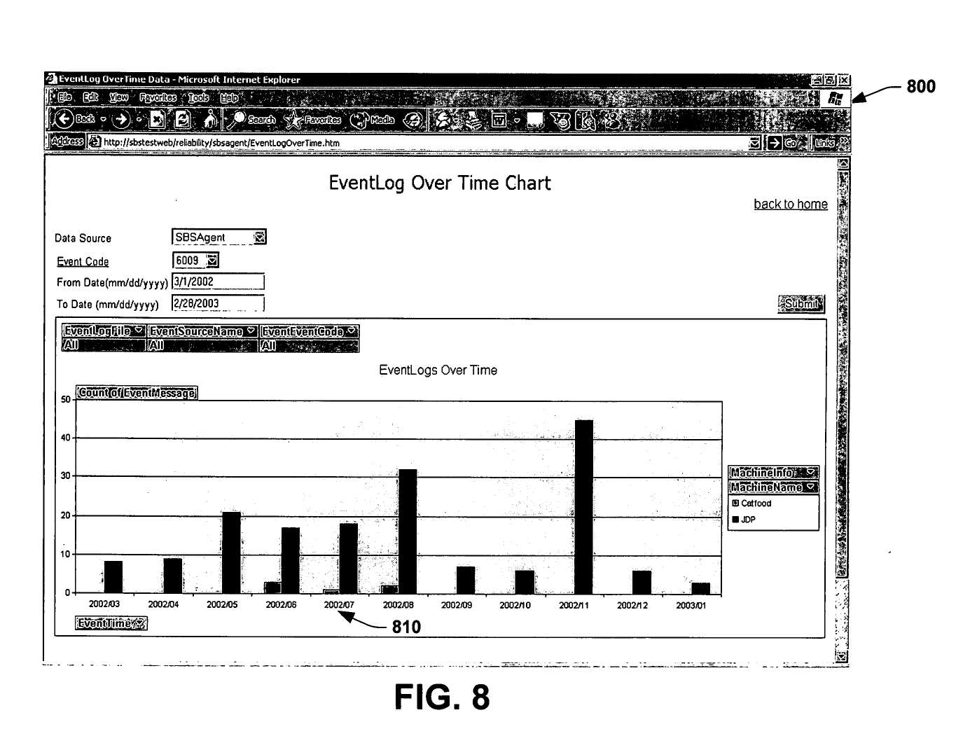

FIG. 6 illustrates a hardware performance chart 600 in bar graph form. This chart illustrates gathered data for several server systems showing current clock speeds along the vertical axis at 610. FIG. 7 depicts an interface 700 showing counter statistics for mail exchanges over time. At 710, the vertical axis illustrates counter values for mail exchanges and at 720, the horizontal axis shows time stamps collected on the dates for the respective counter values. Lines in the direction of left to right along the horizontal axis represent trends in the data over time (e.g., increasing lines representing increased or decreased mail system usage over time). FIG. 8 shows an event log interface 800 that shows a bar graph of error counters over time representing total errors detected by a machine. As illustrated, errors are time-stamped along the horizontal axis at 810.

It is noted that the user interfaces described above can be provided as a Graphical User Interface (GUI) or other type (e.g., audio or video file describing usage and state data). For example, the interfaces can include one or more display objects (e.g., icon) that can include such aspects as configurable icons, buttons, sliders, input boxes, selection options, menus, tabs and so forth having multiple configurable dimensions, shapes, colors, text, data and sounds to facilitate operations with the systems described herein. In addition, user inputs can be provided that include a plurality of other inputs or controls for adjusting and configuring one or more aspects of the subject invention. This can include receiving user commands from a mouse, keyboard, speech input, web site, browser, remote web service and/or other device such as a microphone, camera or video input to affect or modify operations of the various components described herein.

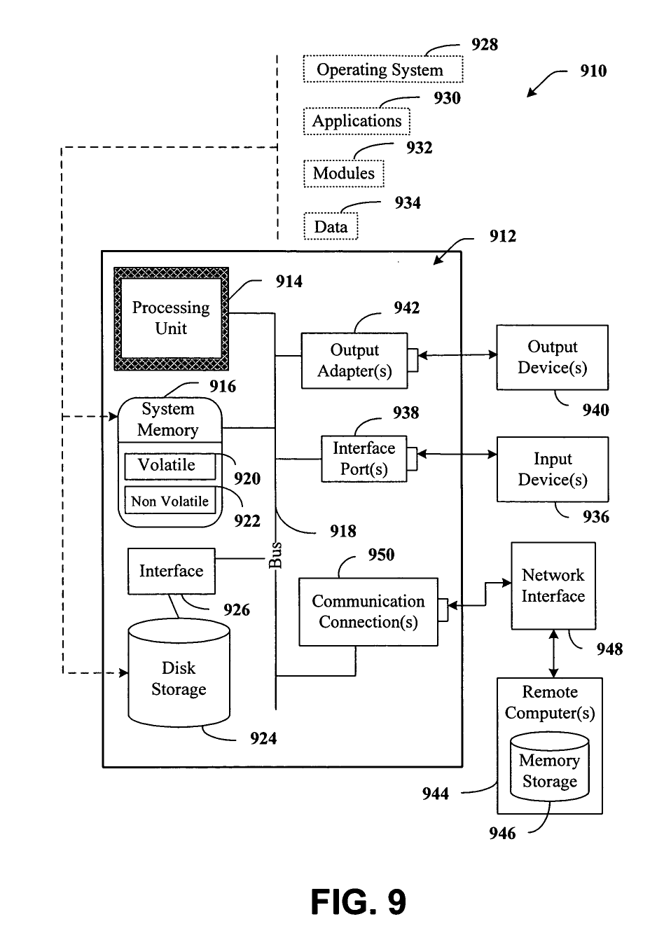

With reference to FIG. 9, an exemplary environment 910 for implementing various aspects of the invention includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that the present invention can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940, that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

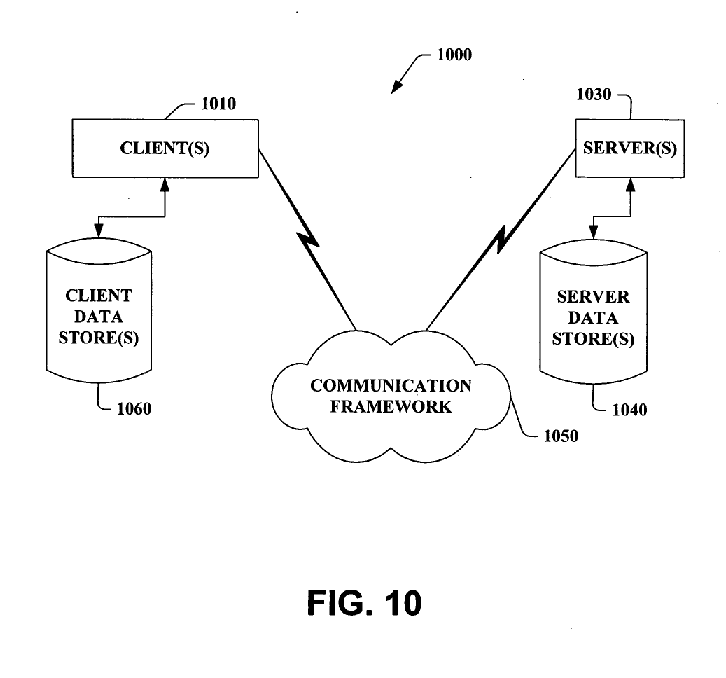

FIG. 10 is a schematic block diagram of a sample-computing environment 1000 with which the present invention can interact. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the present invention, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operably connected to one or more client data store(s) 1060 that can be employed to store information local to the client(s) 1010. Similarly, the server(s) 1030 are operably connected to one or more server data store(s) 1040 that can be employed to store information local to the servers 1030.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for automatically generating computer usage and state data, comprising:
an application layer associated with an operating system to gather data from one or more computer components; and
a collection file to specify the data to gather.

2. The system of claim 1, the application layer queries computer and usage data from one or more client or server machines, and transmits the data over a network to at least one centralized database for further analysis.

3. The system of claim 2, further comprising a scheduler that executes at differing or predetermined time intervals to send data across the network via a sending component.

4. The system of claim 2, the scheduler operates from instructions within a collection file to query the application layer for computer usage and state data and to determine times to execute one or more tasks.

5. The system of claim 4, the collection file includes query and timing commands that are directed to the application layer which in turn gathers client or server machines.

6. The system of claim 1, further comprising a component to analyze the gathered data.

7. The system of claim 1, the data is gathered via electronic mail exchanges.

8. The system of claim 1, the data includes event logs which reflect client or server availability and failures, hardware profile and utilization information on services including messaging and the Internet.

9. The system of claim 8, the data further comprises hardware information including CPU performance data, RAM memory capacity/utilization, available disk space, Input or Output transactions between devices, system bus performance data including bus latencies and bus though-puts.

10. The system of claim 8, the data further comprises device data including network cards, USB adapters, disk controllers, keyboard drivers, sensor drivers, mouse drivers, display drivers, printer drivers, application components, and system, bus, or device interrupt performance.

11. The system of claim 8, the data further comprises node connection data, message sent, delivered and received data, file sharing data, server information or client information, statistics relating to the number of print jobs completed successfully or unsuccessfully, and computer, application, or device failure information.

12. The system of claim 1, the application layer 110 is associated with one or more Windows Management Infrastructure Application Programming Interfaces.

13. The system of claim 1, the data is formatted into an XML file and transmitted through SMTP or HTTP protocol.

14. The system of claim 3, the scheduler executes a task that is to be performed currently, determines a task to be performed next, calculates the time the next gathering of data should be carried out, and schedules a task to run at the next gathering.

15. The system of claim 3, further comprising a data sending module that sends data and is loaded by the scheduler on a predetermined basis.

16. The system of claim 4, the collection file employs a Windows Query Language.

17. A computer readable medium having computer readable instructions stored thereon for implementing the components of claim 1.

18. A system for automatically generating and gathering computer usage and state data, comprising:
means for specifying computer usage data to gather;
means for scheduling tasks to gather the data;
means for querying for the data in accordance with the tasks; and
means for sending the data across a network.

19. The system of claim 18, further comprising means for collecting the data at a remote location.

20. A computer readable medium having a data structure stored thereon for collecting data, comprising:
at least one data field describing a time element related to a period for collecting computer statistical data; and
at least a second data field describing at least one query that commands the collecting of the computer statistical data.

21. The computer readable medium of claim 20, further comprising a field representing at least one of a Local Time, a Task Start Time, a Frequency, a Task Count, a Sample Count, and a Sample Interval.

22. The computer readable medium of claim 20, further comprising a field representing at least one of a Send XML Frequency, a Send Log Frequency, a Check Modification Frequency, an Input File Last Write Time High, and an Input File Last Write Time Low.

23. The computer readable medium of claim 20, further comprising at least one XML field.

24. The computer readable medium of claim 20, further comprising a field representing at least one of a Check Log File Size Frequency, a Data Collection Input File location, an Input File Version, an Input File Version Url, an Input File Url, and a Check Input File Version Frequency.

25. The computer readable medium of claim 20, further comprising a field representing at least one of a Frequency Threshold, an Aggregation Threshold, an Exit Threshold, a Link List File, a Log File, a Log Severity, a Log Facility, an XML Output File Max Size, a scheduler name, a Stop File Grow Threshold, a Send File Hour, and Send File Minute.

26. The computer readable medium of claim 20, further comprising a field representing at least one of an Output File, a Collection Site Version, a Collection Site ID, a network Protocol specification, a network From Address, a network Destination Address, and a Protocol Server location.

27. A method for automatically generating and gathering computer usage and state data, comprising:
describing computer usage data to gather via a collection file;
automatically scheduling tasks to gather the data;
automatically querying for the data in response to the tasks; and
transmitting the data across a network to a centralized collection server for further analysis.

28. The method of claim 27, further comprising updating the collection file for new data to gather via the network.

29. The method of claim 27, further comprising calling a data sending component to transmit the data over the network.

30. The method of claim 27, further comprising automatically generating a log file in accordance with the tasks.

31. The method of claim 27, further comprising polling one or more configuration keys in the collection file.

32. The method of claim 27, further comprising updating an event or counter log in accordance with gathering the data.

33. The method of claim 27, further comprising displaying the data via a graphical user interface to analyze the data.

34. The method of claim 33, the user interface includes performance information, counter information, failure information, and time-stamp information.
